(19) United States
(12) Patent Application Publication
(10) Pub. No.: US 2023/0035896 A1
(43) Pub. Date: Feb. 2, 2023

(54) WIRELESS COMMUNICATION SYSTEM, BASE STATION CONTROL DEVICE, COMMUNICATION CONTROL METHOD, AND COMMUNICATION CONTROL PROGRAM

(71) Applicant: NIPPON TELEGRAPH AND TELEPHONE CORPORATION, Tokyo (JP)

(72) Inventors: Hirantha ABEYSEKERA, Musashino-shi, Tokyo (JP); Toshiro NAKAHIRA, Musashino-shi, Tokyo (JP); Shoko SHINOHARA, Musashino-shi, Tokyo (JP); Koichi ISHIHARA, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 17/791,201

(22) PCT Filed: Jan. 28, 2020
(86) PCT No.: PCT/JP2020/002982

§ 371 Date: Jul. 6, 2022

(51) Int. Cl. H04W 72/12; H04L 5/00

(52) U.S. Cl. CPC H04W 72/1231; H04W 72/1247; H04L 5/0035

(57) ABSTRACT

In a wireless communication system including a plurality of base stations to which terminal stations are connectable and a base station control device which controls each of the base stations, the base station control device includes an information collection unit configured to collect wireless environment information indicating wireless environments around the base stations and the terminal stations from each of the base stations, a parameter calculation unit configured to calculate a parameter for correcting radio wave interference relationship among the base stations based on the wireless environment information collected by the information collection unit and priority set in advance for each of the base stations, and a transmission unit configured to transmit the parameter calculated by the parameter calculation unit to each of the base stations, and each of the base stations includes a reception unit configured to receive the parameter transmitted by the transmission unit, and a setting unit configured to perform setting so as to correct radio wave interference relationship with other base stations based on the parameter received by the reception unit.

### TECHNICAL FIELD

The present invention relates to a wireless communication system, a base station control device, a communication control method, and a communication control program.

### BACKGROUND ART

In recent years, a wide spread of high-performance portable wireless terminals such as notebook computers and smartphones has led a wireless local area network (LAN) which complies with IEEE802.11 standards to be widely used also at home, let alone at companies and in publicly accessible spaces.

The wireless LAN which complies with IEEE802.11 standards includes a wireless LAN complying with IEEE802.11b/g/n standards in which a 2.4 GHz band is used and a wireless LAN complying with IEEE802.11a/n/ac standards in which a 5 GHz band is used.

In the wireless LAN complying with IEEE802.11b standards and IEEE802.11g standards, 13 channels are prepared at intervals of 5 MHz from 2400 MHz to 2483.5 MHz. However, in a case where a plurality of channels are used at the same location, it is possible to use up to three channels or four channels at the same time by using channels so that spectra do not overlap with each other to avoid interference.

In the wireless LAN complying with IEEE802.11a standards, a total of 19 channels including 8 channels and 11 channels which do not overlap with each other are respectively defined between 5170 MHz and 5330 MHz and between 5490 MHz and 5710 MHz in Japan. Note that in IEEE802.11a standards, a band width per channel is fixed at 20 MHz.

Maximum transmission speed of the wireless LAN is 11 Mbps in IEEE802.11b standards and is 54 Mbps in IEEE802.11a standards and IEEE802.11g standards. However, the transmission speed here is transmission speed on a physical layer.

Actually, transmission efficiency in a medium access control (MAC) layer is approximately from 50 to 70%, and thus, an upper limit value of throughput is approximately 5 Mbps in IEEE802.11b standards and is approximately 30 Mbps in IEEE802.11a standards and IEEE802.11g standards. Further, transmission speed further decreases if the number of wireless stations which try to transmit information increases.

Meanwhile, in a wired LAN, as well as a 100 Base-T interface of Ethernet (registered trademark), fiber to the home (FTTH) which uses an optical fiber has been spread also at every home, and high-speed lines on the order of 100 Mbps to 1 Gbps are provided. Thus, further higher transmission speed is desired also in the wireless LAN.

In IEEE802.11n standards for which standardization has been completed in 2009, a channel band width which has been fixed at 20 MHz so far is expanded to up to 40 MHz, and introduction of multiple input multiple output (MIMO) technique is determined. If transmission and reception are performed by applying all functions defined in IEEE802.11n standards, communication speed of up to 600 Mbps can be achieved in a physical layer.

Further, in IEEE802.11ac standards for which standardization has been completed in 2013, it is determined to expand a channel band width to 80 MHz or up to 160 MHz (or 80+80 MHz) and introduce a transmission method of multiuser MIMO (MU-MIMO) in which space division multiple access (SDMA) is applied. If transmission and reception are performed by applying all functions defined in IEEE802.11ac standards, communication speed of up to approximately 6.9 Gbps can be achieved in a physical layer.

Further, in IEEE802.11ax standards which are currently under formulation, orthogonal frequency division multiple access (OFDMA) which enables transmission and reception of frames by dividing channels of 20 MHz, 40 MHz, 80 MHz, 160 MHz and 80+80 MHz described above into finer sub-channels, is expected to be defined. Use of OFDMA enables simultaneous transmission by a plurality of wireless stations in unit of a resource unit by dividing the above-described channels into finer sub-channels. Further, a function of increasing communication opportunities while reducing interference from other peripheral cells by control of a carrier sense threshold (CCA threshold) is expected to be defined in IEEE802.11ax standards.

The wireless LAN complying with IEEE802.11 standards is operated in a frequency band of a 2.4 GHz band or a 5 GHz band for which license is not required. In this event, in a case where a base station complying with IEEE802.11 standards forms a wireless LAN cell (basic service set (BSS)), the base station selects one frequency channel from frequency channels which can be supported at the own station and operates the frequency channel.

A channel to be used at the own cell, setting values of a band width and other parameters, and other parameters which can be supported at the own station are described in a Beacon frame which is periodically transmitted, a Probe response frame for a Probe Request frame received from a wireless terminal, or the like. Further, the base station operates the cell by transmitting a frame on the frequency channel which the base station determines to operate and notifying subordinate wireless terminals and other peripheral wireless stations.

Examples of a method for selecting and setting a frequency channel, a band width and other parameters at the base station can include the following four methods:

(1) a method in which default parameter values set in advance at the base station are used as is,
(2) a method in which values manually set by a user who operates the base station are used,
(3) a method in which parameter values are autonomously selected and set based on wireless environment information detected by each base station upon start-up, and
(4) a method in which parameter values determined by a central control station such as a wireless LAN controller are set.

Further, the number of channels which can be used at the same time at the same location is 3 in a wireless LAN of a 2.4 GHz band, and 2, 4, 9 or 19 in a wireless LAN of a 5 GHz band in accordance with a channel band width to be used for communication. Thus, in a case where a wireless LAN is actually introduced, it is necessary to select a channel to be used by the base station within the own BSS (see, for example, Non-Patent Literature 1 and Non-Patent Literature 2).

While the number of channels which can be used at the same time at the same location in a 5 GHz band is 19 channels in a case where the channel band width is 20 MHz, in a case where the channel band width is expanded to 40 MHz, 80 MHz, 160 MHz or 80+80 MHz, the number of channels which can be used at the same time at the same location in a 5 GHz band decreases to 9 channels, 4 channels, and 2 channels. In other words, the number of channels which can be used decreases as the channel band width increases.

In a wireless LAN dense environment where the number of channels which can be used is larger than the number of BSSs, a plurality of BSSs use the same channel (overlapping BSS (OBSS)). Thus, in the wireless LAN, autonomous distributed access control in which data is transmitted only in a case where a channel is available by carrier sense is used using carrier sense multiple access with collision avoidance (CSMA/CA).

Specifically, a wireless station at which a transmission request occurs first performs carrier sense in a predetermined sensing period (distributed inter-frame space (DIFS)) to monitor a state of a wireless medium, and if there is no transmission signal by other wireless stations in this period, performs random back-off. The wireless station continuously performs carrier sense also during a random back-off period, and in a case where there is no transmission signal by other wireless stations also in this period, obtains right to utilize a channel.

Note that whether there is transmission/reception by other wireless stations is determined by whether or not a signal greater than a carrier sense threshold set in advance is received. The wireless station which obtains the right to utilize the channel can transmit data to other wireless stations within the same BSS and can receive data from these other wireless stations.

In a case where such CSMA/CA control is performed, in a wireless LAN dense environment where the same channel is used, a channel becomes busy more frequently by carrier sense, which lowers throughput. It is therefore important to monitor a surrounding environment, select an appropriate channel and select a transmission power value and a carrier sense threshold which enable simultaneous transmission and reception.

Further, a method for selecting the above-described parameters such as a type of 2.4 GHz or 5 GHz which is an operating frequency band of the base station and a channel to be utilized in the operating frequency band is not defined in IEEE802.11 standards, and thus, respective vendors which supply base stations employ individual methods.

### CITATION LIST

### Non-Patent Literature

Non-Patent Literature 1: supervised by Masahiro Morikura, Shuji Kubota, “802.11 high-speed wireless LAN textbook”, revised third edition, Impress R&D, March, 2008
Non-Patent Literature 2: IEEE Standard for Information Technology-Telecommunications and information exchange between systems Local and metropolitan area networks-Specific requirements Part 11: Wireless LAN medium Access Control (MAC) and Physical Layer (PHY) specifications Amendment 8: IEEE 802.11-Wireless Network Management 9 Feb. 2011, p. 8

### SUMMARY OF THE INVENTION

### Technical Problem

However, respective wireless stations select the above-described parameters in an autonomous distributed manner, which makes it impossible to achieve optimization as the whole system, and particularly, in an environment where there are a number of wireless stations, there is a case where user quality largely degrades.

Further, in recent years, the number of wireless stations at which a plurality of wireless modules are mounted has increased. This is because a band width to be used can be expanded and user throughput within a service area can be increased by mounting a plurality of wireless modules in the same chassis and using different frequency bands and different channels.

However, if a frequency band to be used and a channel to be used by each wireless module to be mounted are not appropriately set, there is a problem that the wireless modules interfere with each other as well as the wireless station interferes with other peripheral wireless stations, which makes it impossible to provide assumed service.

An object of the present invention is to provide a wireless communication system, a base station control device, a communication control method, and a communication control program, with which efficient wireless communication can be achieved as the whole system while prioritizing wireless communication in a predetermined area.

### Means for Solving the Problem

A wireless communication system according to one aspect of the present invention is a wireless communication system including a plurality of base stations to which terminal stations are connectable, and a base station control device which controls each of the base stations, the base station control device including an information collection unit configured to collect wireless environment information indicating wireless environments around the base stations and the terminal stations from each of the base stations, a parameter calculation unit configured to calculate a parameter for correcting radio wave interference relationship among the base stations based on the wireless environment information collected by the information collection unit and priority set in advance for each of the base stations, and a transmission unit configured to transmit the parameter calculated by the parameter calculation unit to each of the base stations, and each of the base stations including a reception unit configured to receive the parameter transmitted by the transmission unit, and a setting unit configured to perform setting so as to correct radio wave interference relationship with other base stations based on the parameter received by the reception unit.

Further, a base station control device according to one aspect of the present invention is a base station control device which controls each of a plurality of base stations to which terminal stations are connectable, the base station control device including an information collection unit configured to collect wireless environment information indicating wireless environments around the base stations and the terminal stations from each of the base stations, a parameter calculation unit configured to calculate a parameter for correcting radio wave interference relationship among the base stations based on the wireless environment information collected by the information collection unit and priority set in advance for each of the base stations, and a transmission unit configured to transmit the parameter calculated by the parameter calculation unit to each of the base stations.

Further, a communication control method according to one aspect of the present invention is a communication control method for controlling each of a plurality of base stations to which terminal stations are connectable, the communication control method including an information collection step of collecting wireless environment information indicating wireless environments around the base stations and the terminal stations from each of the base stations, a parameter calculation step of calculating a parameter for correcting radio wave interference relationship among the base stations based on the collected wireless environment information and priority set in advance for each of the base stations, and a transmission step of transmitting the calculated parameter to each of the base stations.

### Effects of the Invention

According to the present invention, it is possible to achieve efficient wireless communication as the whole system while prioritizing wireless communication in a predetermined area.

### BRIEF DESCRIPTION OF DRAWINGS

FIG. 1 illustrates a configuration example of a wireless communication system according to one embodiment.

FIG. 2 is a functional block diagram illustrating an example of functions of a terminal station.

FIG. 3 is a functional block diagram illustrating an example of functions of a base station.

FIG. 4 is a functional block diagram illustrating an example of functions of a base station control device according to one embodiment.

FIG. 5 is a flowchart illustrating an operation example of the base station control device according to one embodiment.

FIG. 6 provides views: the view(a) illustrates radio wave interference relationship among base stations before the wireless communication system corrects the radio wave interference relationship; and the view(b) illustrates radio wave interference relationship among the base stations after the wireless communication system corrects the radio wave interference relationship.

FIG. 7 provides views: the view(a) illustrates radio wave interference relationship among the base stations before the wireless communication system corrects the radio wave interference relationship; and the view(b) illustrates radio wave interference relationship among the base stations after the wireless communication system corrects the radio wave interference relationship.

FIG. 8 illustrates a hardware configuration example of the base station control device according to one embodiment.

### DESCRIPTION OF EMBODIMENTS

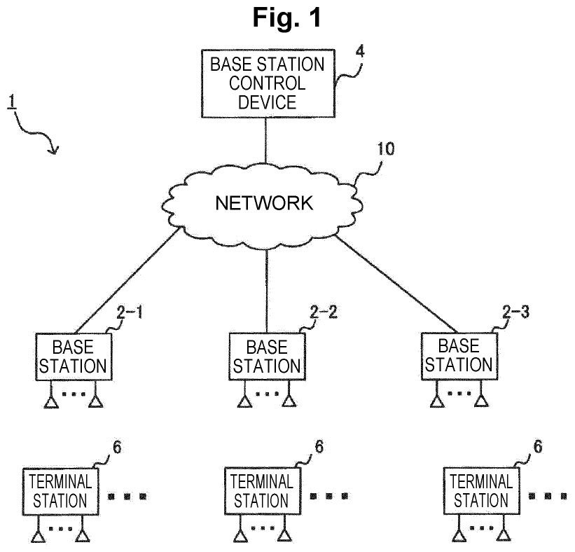

One embodiment of a wireless communication system will be described below using the drawings. FIG. 1 illustrates a configuration example of a wireless communication system 1 according to one embodiment. As illustrated in FIG. 1, the wireless communication system 1 is constituted by, for example, base stations (AP) 2-1 to 2-3 being respectively connected to a base station control device 4 via a network 10.

Priority is set in advance at each of the base stations 2-1 to 2-3 for an area (cell) in which the base stations 2-1 to 2-3 enable wireless communication. For example, one of three levels of priority of high, medium and low is set at each of the base stations 2-1 to 2-3.

A plurality of terminal stations 6 which are located around the base stations 2-1 to 2-3 are connectable to the base stations 2-1 to 2-3.

In other words, in the wireless communication system 1, an area in which one of the base stations 2-1 to 2-3 whose priority is set at “high” enables wireless communication is set as a so-called “premier area”, and wireless communication by the terminal station 6 which is located within the premier area is prioritized.

Note that while an example of a case will be described where the wireless communication system 1 operates while complying with, for example, IEEE802.11ax standards, the system is not limited to this, and the system may operate while complying with other communication standards. Hereinafter, a component which is not specified among a plurality of components as the base stations 2-1 to 2-3 will be simply abbreviated as a base station 2, or the like.

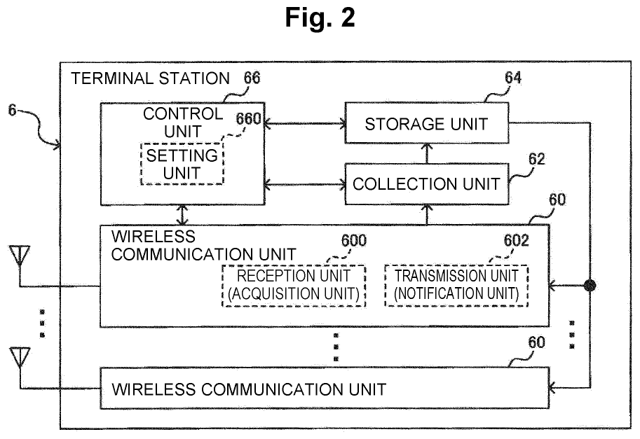

The terminal station 6 will be described first. FIG. 2 is a functional block diagram illustrating an example of functions of the terminal station 6. As illustrated in FIG. 2, the terminal station 6 includes, for example, a plurality of wireless communication units 60, a collection unit 62, a storage unit 64, and a control unit 66.

The wireless communication unit 60 includes a reception unit (acquisition unit) 600 and a transmission unit (notification unit) 602 and performs wireless communication with the base station 2 and other terminal stations 6.

The reception unit 600 acquires information by receiving signals transmitted by, for example, the base station 2 and other terminal stations 6 and outputs the information to the collection unit 62. The transmission unit 602 transmits (notifies) information, for example, stored in the storage unit 64 to the base station 2 and other terminal stations 6. Note that the wireless communication units 60 may use different frequency bands or may employ different communication schemes or may perform communication using the same communication scheme.

The collection unit 62 collects wireless environment information, or the like, indicating wireless environments around, for example, the base station 2 and other terminal stations 6 via the wireless communication unit 60 and outputs the wireless environment information, or the like, to the storage unit 64. The storage unit 64 stores the wireless environment information, or the like, collected by the collection unit 62.

The control unit 66 includes a setting unit 660 and controls respective units which constitute the terminal station 6. For example, the setting unit 660 performs setting for operation of the terminal station 6 based on information acquired by the wireless communication unit 60 from the base station 2.

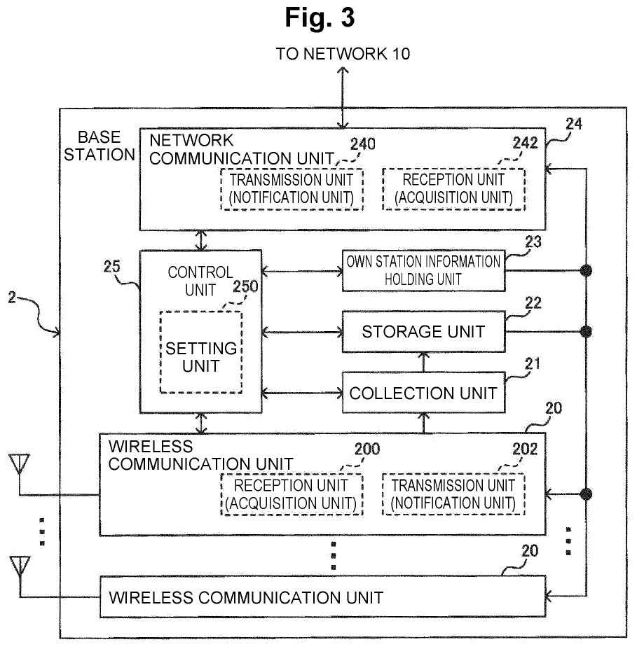

The base station 2 will be described next. FIG. 3 is a functional block diagram illustrating an example of functions of the base station 2. As illustrated in FIG. 3, the base station 2 includes, for example, a plurality of wireless communication units 20, a collection unit 21, a storage unit 22, an own station information holding unit 23, a network communication unit 24, and a control unit 25.

The wireless communication unit 20 includes a reception unit (acquisition unit) 200 and a transmission unit (notification unit) 202 and performs wireless communication with other base stations 2 and the terminal station 6.

The reception unit 200 acquires information by receiving signals transmitted by, for example, other base stations 2 and the terminal station 6 and outputs the information to the collection unit 21. The transmission unit 202 transmits (notifies) signals indicating, for example, information stored in the storage unit 64, own station information (which will be described later) held by the own station information holding unit 23, information acquired by the network communication unit 24 from the base station control device 4, or the like, to other base stations 2 and the terminal station 6. Note that the wireless communication units 20 may use different frequency bands or may employ different communication schemes or may perform communication using the same communication scheme.

The collection unit 21 collects wireless environment information, or the like, including a plurality of information items indicating, for example, wireless environments around other base stations 2 and the terminal station 6 from other base stations 2 and the terminal station 6 via the wireless communication units 20 and outputs the wireless environment information, or the like, to the storage unit 22. Note that the wireless environment information may include information regarding communication between the base station 2 and the terminal station 6 and information regarding an operation state of the base station 2. The storage unit 22 stores the wireless environment information, or the like, collected by the collection unit 21.

The own station information holding unit 23 holds information regarding the base station 2. For example, the own station information holding unit 23 holds own station information including specifications, functions, and the like, of the own station, such as a frequency band and a communication scheme to be used by the base station 2, the number of connectable terminal stations and the number of wireless communication units 20.

The network communication unit 24 includes a transmission unit (notification unit) 240 and a reception unit (acquisition unit) 242 and performs wired communication or wireless communication with the base station control device 4 via the network 10.

The transmission unit 240 transmits (notifies) signals indicating, for example, the information stored in the storage unit 22 and the own station information held by the own station information holding unit 23 to the base station control device 4. The reception unit 242 acquires information (for example, a parameter which will be described later) by receiving signals transmitted by the base station control device 4. Further, the reception unit 242 outputs information which is received from the base station control device 4 and which should be transmitted to the terminal station 6, to the wireless communication unit 20.

The control unit 25 includes a setting unit 250 and controls respective units which constitute the base station 2. For example, the setting unit 250 performs setting for operation of the base station 2 based on the information acquired by the network communication unit 24 from the base station control device 4, the information acquired by the wireless communication unit 20 from the terminal station 6, and the like.

For example, the setting unit 250 performs setting for operation of the base station 2 so as to correct radio wave interference relationship with other base stations based on the parameter received by the reception unit 242. Further, the setting unit 250 may perform setting for operation of the terminal station 6.

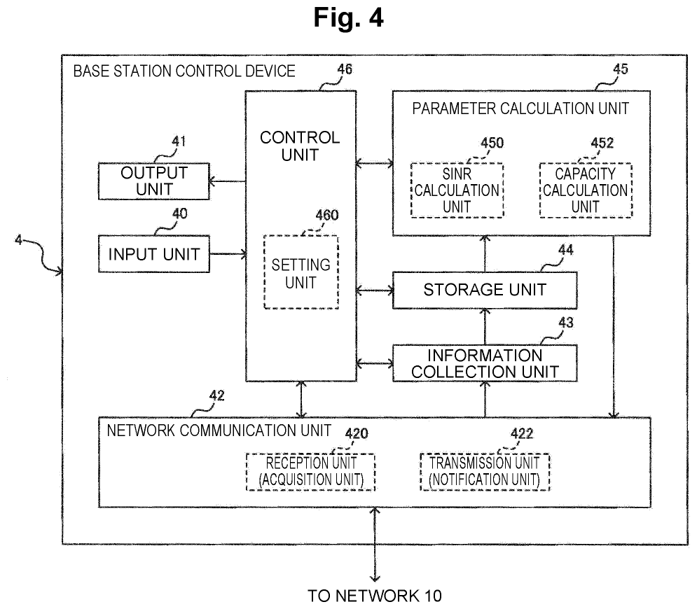

The base station control device 4 will be described next. FIG. 4 is a functional block diagram illustrating an example of functions of the base station control device 4 according to one embodiment. As illustrated in FIG. 4, the base station control device 4 includes, for example, an input unit 40, an output unit 41, a network communication unit 42, an information collection unit 43, a storage unit 44, a parameter calculation unit 45 and a control unit 46.

The input unit 40 accepts input (such as instructions and settings) by a worker with respect to the base station control device 4. The output unit 41 outputs results, or the like, of processing by the base station control device 4 to show the results, or the like, to the worker.

The network communication unit 42 includes a reception unit (acquisition unit) 420 and a transmission unit (notification unit) 422 and performs wired communication or wireless communication with the base stations 2-1 to 2-3 via the network 10.

The reception unit 420 receives information respectively transmitted by the base stations 2-1 to 2-3 and outputs the received information to the information collection unit 43. The transmission unit 422 transmits information, or the like, processed by the base station control device 4 to the base stations 2-1 to 2-3. For example, the transmission unit 422 transmits the parameter calculated by the parameter calculation unit 45 to the base stations 2-1 to 2-3.

The information collection unit 43 collects the information received by the reception unit 420 and outputs the information to the storage unit 44. For example, the information collection unit 43 collects wireless environment information such as an operation log including a plurality of information items indicating wireless environments around each base station 2 and each terminal station 6 from each of the base stations 2-1 to 2-3 and causes the collected results to be stored in the storage unit 44.

The information items included in the wireless environment information include, for example, strength of a received signal strength indicator (RSSI), traffic, the number of terminal stations 6 connected to the base station 2 (the number of connected terminals), channel utilization, a data rate, a channel transition log, or the like.

The parameter calculation unit 45, which includes a signal to interference plus noise power ratio (SINR) calculation unit 450 and a capacity calculation unit 452, calculates a parameter for correcting radio wave interference relationship among the base stations based on the wireless environment information stored in the storage unit 44 and the priority set in advance for the base stations 2-1 to 2-3. For example, the parameter calculation unit 45 calculates a parameter so as to prioritize communication at a base station with higher priority over communication at a base station with lower priority.

Specifically, the parameter calculation unit 45 calculates a parameter for correcting radio wave interference relationship among the base stations by converting radio field strength of respective base stations with reference to a base station with the highest priority. For example, the parameter calculation unit 45 calculates a channel and a band width as part of the parameter so as to maximize an SINR in the corrected radio wave interference relationship or minimize an interference to noise power ratio (INR).

Further, the parameter calculation unit 45 may calculate a parameter for correcting radio wave interference relationship among the base stations by converting radio field strength of the respective base stations based on weights set in advance for the respective base stations which interfere with other base stations.

In more detail, the SINR calculation unit 450 calculates an SINR of a communication area of one (for example, AP-a) of the base stations 2 using the following expression (1).

$$[ Math . 1 ]$$

$$SIN R ( dB ) = 10 \times {log}_{10} ( \frac{SignalLevel}{Noise + totalinterfecence} ) \\ SignalLevel : true value of desired signal level of subordinate \\ terminal of AP - a \\ Noise : true value of noise level \\ Totalinterfecence : true value of total interference level in \\ communication area of AP - a \qquad ( 1 )$$

Here, the true value of the total interference level in the communication area of one (AP-a) of the base stations 2 is expressed with the following expression (2).

[Math. 2]

Totalinterfecence=Σᵢ₌₁^{N}I_{a,i} (2)
N: all APs which interfere with AP-a
I_{a,i}: value obtained by applying weight w to interference level from AP-i to AP-a

Note that SINRs of all the base stations 2-1 to 2-3 which are to be controlled are calculated assuming that a=1 to 3. Further, it is assumed that the base station which interferes with AP-a is a base station which uses at least part of the channel and the band width used by AP-a. Here, the SINR calculation unit 450 determines whether or not interference occurs using, for example, RSSI=−62 dBm as a threshold.

Further, a weight w for the RSSI is determined in accordance with priority respectively set at a non-interfering base station (reception side) and an interfering base station (transmission side). For example, a value of the weight w is set at +10 dBm for the base station 2 with “high” priority. Further, the value of the weight w is set at 0 dBm for the base station 2 with “medium” priority. Further, the value of the weight w is set at −10 dBm for the base station 2 with “low” priority.

Further, the capacity calculation unit 452 calculates capacity Ca of AP-a using the following expression (3).

$$[ Math . 3 ]$$

$$Ca ( Mbit / s ) = \frac{B}{n} \times {log}_{2} ( 1 + SINR\_norm ) \\ B : band width used by AP - a ( MHz ) \\ n : total number of Aps sharing channels with AP - a \\ SINR\_norm : true value of \\ SIN R of communication area of AP - x \qquad ( 3 )$$

It is assumed here that the total number of base stations (APs) which share a channel with AP-a is the number of base stations which use at least part of the channel and the band width used by AP-a. For example, the capacity calculation unit 452 calculates the capacity using RSSI=−82 dBm as a threshold assuming that the total number of base stations which share a channel with AP-a is the number of peripheral base stations which are interfered+1.

Note that the parameter calculation unit 45 may include an INR calculation unit which calculates the INR described above in place of the SINR calculation unit 450 which calculates an SINR.

The control unit 46, which includes a setting unit 460, controls respective units which constitute the base station control device 4. Further, the control unit 46 causes results obtained by respective units which constitute the base station control device 4 processing information, to be stored in the storage unit 44.

The setting unit 460 performs setting for the respective units which constitute the base station control device 4. For example, the setting unit 460 performs setting for the information collection unit 43 and the parameter calculation unit 45 based on settings input by the worker via the input unit 40.

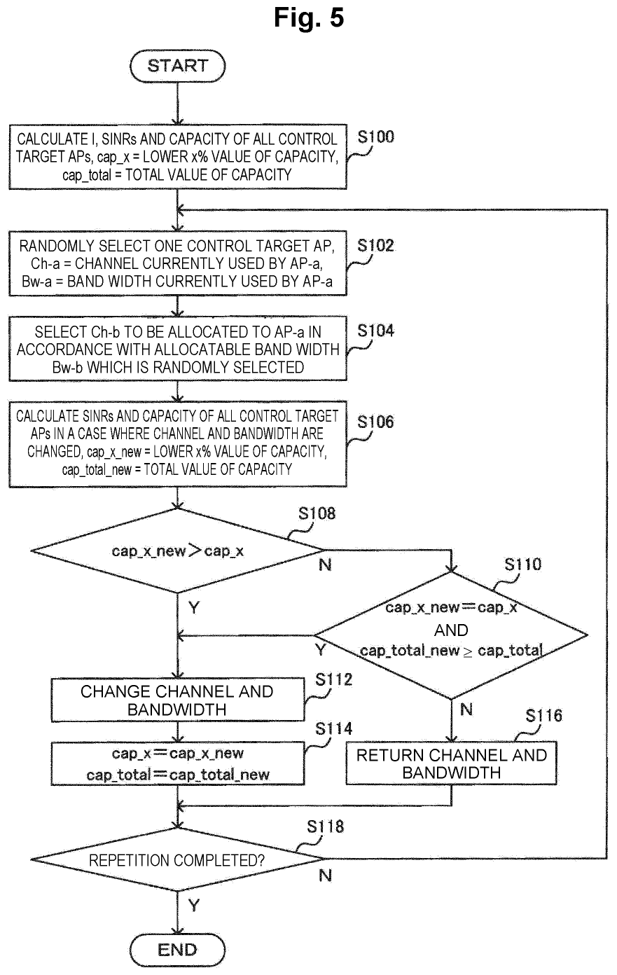

An operation example of the base station control device 4 will be described next. FIG. 5 is a flowchart illustrating the operation example of the base station control device 4. As illustrated in FIG. 5, the base station control device 4 first calculates values I obtained by applying the weights w to the interference levels, the SINRs and the capacity for all control target base stations (APs) (S100). Here, the base station control device 4 sets a lower x % value of capacity as cap_x and sets a total value of capacity as cap_total.

Then, the base station control device 4 randomly selects one control target base station (S102). Here, the base station control device 4 sets a channel currently used by AP-a as Ch-a and sets a band width currently used by AP-a as Bw-a.

Further, the base station control device 4 selects a channel Ch-b to be allocated to AP-a in accordance with an allocatable band width Bw-b which is randomly selected (S104).

Then, the base station control device 4 calculates SINRs and capacity for all the control target base stations (APs) in a case where the channel and the band width of AP-a are changed to Ch-b and Bw-b (S106). Here, the base station control device 4 sets a lower x % value of capacity as cap_x_new and sets a total value of capacity as cap_total_new.

Then, the base station control device 4 determines whether or not cap_x_new is greater than cap_x (S108), in a case where cap_x_new is equal to or less than cap_x (S108: No), the processing proceeds to S110, and in a case where cap_x_new is greater than cap_x (S108: Yes), the processing proceeds to S112.

In the processing in S110, the base station control device 4 determines whether or not cap_x_new=cap_x and cap_total_new≥cap_total, and in a case where the condition is satisfied (S110: Yes), the processing proceeds to S112, and in a case where the condition is not satisfied (S110: No), the processing proceeds to S116.

In the processing in S112, the base station control device 4 changes the channel and the bandwidth of AP-a to Ch-b and Bw-b. The base station control device 4 then makes changes so that cap_x=cap_x_new and cap_total=cap_total_new (S114).

In the processing in S116, the base station control device 4 returns the channel and the band width of AP-a to Ch-a and Bw-a.

The base station control device 4 then determines whether or not repetition of processing for all the control target base stations has been completed (S118), and in a case where repetition has not been completed (S118: No), the processing proceeds to S102, and in a case where repetition has been completed (S118: Yes), the processing ends.

A specific operation example of the wireless communication system 1 will be described next. Description will be provided below using an example of a case where priority of the base station 2-1 is the highest (priority: high), and priority of the base stations 2-2 and 2-3 is low (priority: low). Further, it is assumed that channels of the base stations 2-1 to 2-3 are all 144 ch, and band widths of the base stations 2-1 to 2-3 are all 20 MHz. Further, the value of the weight w is set at +10 dBM for the base station 2-1 with “high” priority, and the value of the weight w is set at −10 dBm for the base stations 2-2 and 2-3 with “low” priority.

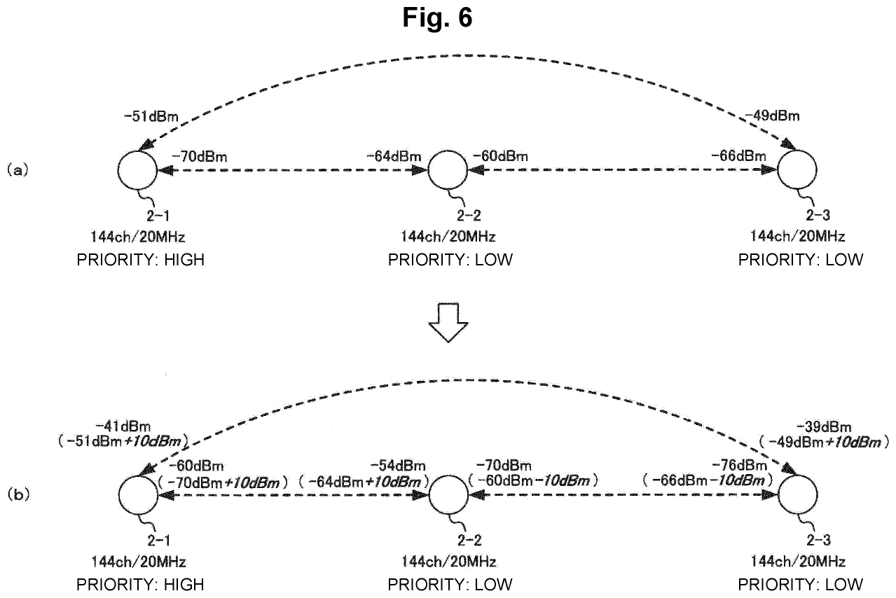

FIG. 6 schematically illustrates a first example of specific operation of the wireless communication system 1. FIG. 6(a) illustrates mutual radio wave interference relationship among the base stations 2-1 to 2-3 before the wireless communication system 1 corrects the radio wave interference relationship. FIG. 6(b) illustrates mutual radio wave interference relationship among the base stations 2-1 to 2-3 after the wireless communication system 1 corrects the radio wave interference relationship.

It is assumed in a state illustrated in FIG. 6(a) where the wireless communication system 1 corrects the radio wave interference relationship that a radio wave from the base station 2-1 to the base station 2-2 is −64 dBm, and a radio wave from the base station 2-1 to the base station 2-3 is −49 dBm. It is assumed that a radio wave from the base station 2-2 to the base station 2-1 is −70 dBm, and a radio wave from the base station 2-2 to the base station 2-3 is −66 dBm. Further, it is assumed that a radio wave from the base station 2-3 to the base station 2-1 is −51 dBm, and a radio wave from the base station 2-3 to the base station 2-2 is −60 dBm.

In contrast, in a state illustrated in FIG. 6(b) after the wireless communication system 1 corrects the radio wave interference relationship, the radio wave from the base station 2-1 to the base station 2-2 becomes −54 dBm, and the radio wave from the base station 2-1 to the base station 2-3 becomes −39 dBm. The radio wave from the base station 2-2 to the base station 2-1 becomes −60 dBm, and the radio wave from the base station 2-2 to the base station 2-3 becomes −76 dBm. Further, the radio wave from the base station 2-3 to the base station 2-1 becomes −41 dBm, and the radio wave from the base station 2-3 to the base station 2-2 becomes −70 dBm.

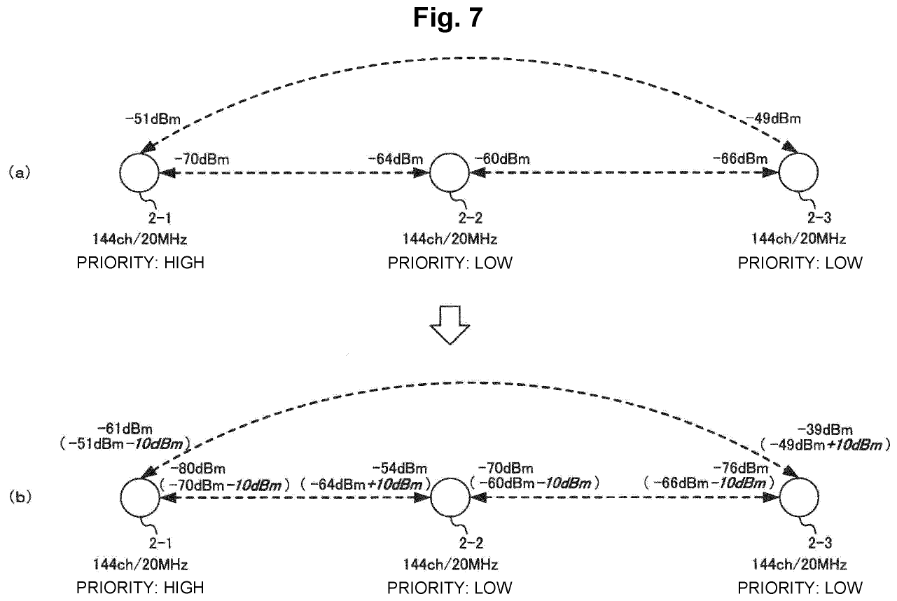

FIG. 7 schematically illustrates a second example of the specific operation of the wireless communication system 1. FIG. 7(a) illustrates mutual radio wave interference relationship among the base stations 2-1 to 2-3 before the wireless communication system 1 corrects the radio wave interference relationship. FIG. 7(b) illustrates mutual radio wave interference relationship among the base stations 2-1 to 2-3 after the wireless communication system 1 corrects the radio wave interference relationship.

It is assumed in a state illustrated in FIG. 7(a) before the wireless communication system 1 corrects the radio wave interference relationship that a radio wave from the base station 2-1 to the base station 2-2 is −64 dBM, and a radio wave from the base station 2-1 to the base station 2-3 is −49 dBm. It is assumed that a radio wave from the base station 2-2 to the base station 2-1 is −70 dBm, and a radio wave from the base station 2-2 to the base station 2-3 is −66 dBm. Further, it is assumed that a radio wave from the base station 2-3 to the base station 2-1 is −51 dBm, and a radio wave from the base station 2-3 to the base station 2-2 is −60 dBm.

In contrast, in a state illustrated in FIG. 7(b) after the wireless communication system 1 corrects the radio wave interference relationship, the radio wave from the base station 2-1 to the base station 2-2 becomes −54 dBm, and the radio wave from the base station 2-1 to the base station 2-3 becomes −39 dBm. The radio wave from the base station 2-2 to the base station 2-1 becomes −80 dBm, and the radio wave from the base station 2-2 to the base station 2-3 becomes −76 dBm. Further, the radio wave from the base station 2-3 to the base station 2-1 becomes −61 dBm, and the radio wave from the base station 2-3 to the base station 2-2 becomes −70 dBm.

Note that in a case where the radio wave interference relationship is corrected so that the radio wave becomes +10 dBm in accordance with the value of the weight w, this correction is equivalent to correction performed in a case where a distance between the base stations is closer (interference is larger). Further, in a case where the radio wave interference relationship is corrected so that the radio wave becomes −10 dBm in accordance with the value of the weight w, this correction is equivalent to correction performed in a case where a distance between the base stations is farther (interference is smaller).

In this manner, the wireless communication system 1 can achieve efficient wireless communication as the whole system while prioritizing wireless communication in a predetermined area by correcting the radio wave interference relationship among the base stations.

In other words, the wireless communication system 1 can set a parameter at a predetermined base station so as to prioritize wireless communication in a predetermined area and can deploy service which is different from service provided to other peripheral base stations. In other words, the wireless communication system 1 can efficiently implement a so-called premier area in which higher-speed and improvement in quality are achieved by prioritizing wireless communication.

Note that part or all of respective functions of the base station 2, the base station control device 4 and the terminal station 6 may be implemented with hardware such as a programmable logic device (PLD) and a field programmable gate array (FPGA) or may be implemented as a program to be executed by a processor such as a CPU.

For example, the base station control device 4 according to the present invention can be implemented using a computer and a program, and the program can be recorded in a storage medium or can be provided through a network.

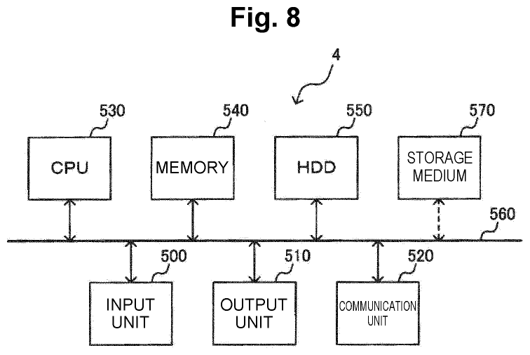

FIG. 8 illustrates a hardware configuration example of the base station control device 4 (the base station 2, the terminal station 6) according to one embodiment. As illustrated in FIG. 8, for example, the base station control device 4, to which an input unit 500, an output unit 510, a communication unit 520, a CPU 530, a memory 540 and an HDD 550 are connected via a bus 560, has functions as a computer. Further, the base station control device 4 can input/output data to/from a computer-readable storage medium 570.

The input unit 500 is, for example, a keyboard, a mouse, or the like. The output unit 510 is, for example, a display device such as a display. The communication unit 520, which is, for example, a wired or wireless network interface, can perform a plurality of wireless communications.

The CPU 530 controls respective units which constitute the base station control device 4 and performs calculation, or the like, described above. The memory 540 and the HDD 550 constitute the storage unit 44 described above which stores data. Particularly, the memory 540 stores respective pieces of data to be used for calculation described above. The storage medium 570 can store a wireless communication program, or the like, for executing functions of the base station control device 4. Note that architecture constituting the base station control device 4 (the base station 2, the terminal station 6) is not limited to the example illustrated in FIG. 9.

In other words, it is assumed that the “computer” described here includes hardware such as an OS and peripheral equipment. Further, the “computer-readable storage medium” indicates a storage device such as a portable medium such as a flexible disk, a magnetooptical disk, a ROM and a CD-ROM.

Further, the “computer-readable storage medium” may include a medium which dynamically holds a program in a short period, such as a communication line in a case where a program is transmitted via a network such as the Internet or a communication line such as a telephone line, and a medium which holds a program in a certain period, such as a volatile memory inside a computer which becomes a server or a client in that case.

While the embodiment of the present invention has been described above with reference to the drawings, the above-described embodiment is merely an example of the present invention, and it is obvious that the present invention is not limited to the above-described embodiment. Thus, components may be added, omitted, replaced, or changed within a range not deviating from the technical idea and the scope of the present invention.

### REFERENCE SIGNS LIST

1 Wireless communication system
2-1 to 2-3 Base station
4 Base station control device
6 Terminal station
20 Wireless communication unit
21 Collection unit
22 Storage unit
23 Own station information holding unit
24 Network communication unit
25 Control unit
40 Input unit
41 Output unit
42 Network communication unit
43 Information collection unit
44 Storage unit
45 Parameter calculation unit
46 Control unit
60 Wireless communication unit
62 Collection unit
64 Storage unit
66 Control unit
200, 242, 420, 600 Reception unit (acquisition unit)
202, 240, 422, 602 Transmission unit (notification unit)
250, 460, 660 Setting unit
450 SINR calculation unit
452 Capacity calculation unit
500 Input unit
510 Output unit
520 Communication unit
530 CPU
540 Memory
550 HDD
560 Bus
570 Storage medium

1. A wireless communication system comprising:
a plurality of base stations to which terminal stations are connectable; and
a base station control device which controls each of the base stations, the base station control device comprising:
an information collection unit configured to collect wireless environment information indicating wireless environments around the base stations and the terminal stations from each of the base stations;
a parameter calculation unit configured to calculate a parameter for correcting radio wave interference relationship among the base stations based on the wireless environment information collected by the information collection unit and priority set in advance for each of the base stations; and
a transmission unit configured to transmit the parameter calculated by the parameter calculation unit to each of the base stations, and
each of the base stations comprising:
a reception unit configured to receive the parameter transmitted by the transmission unit; and
a setting unit configured to perform setting so as to correct radio wave interference relationship with other base stations based on the parameter received by the reception unit.

2. The wireless communication system according to claim 1, wherein the parameter calculation unit calculates the parameter so as to prioritize communication at a base station with higher priority over communication at a base station with lower priority.

3. The wireless communication system according to claim 2, wherein the parameter calculation unit calculates the parameter for correcting the radio wave interference relationship among the base stations by converting radio field strength of each of the base stations with reference to a base station with the highest priority.

4. The wireless communication system according to claim 2, wherein the parameter calculation unit calculates the parameter for correcting the radio wave interference relationship among the base stations by converting radio field strength of each of the base stations based on a weight set in advance at each of the base stations which interfere with other base stations.

5. The wireless communication system according to claim 2,
wherein the parameter calculation unit calculates a channel and a band width as part of a parameter so as to maximize an SINR in the corrected radio wave interference relationship or minimize an INR.

6. A base station control device which controls each of a plurality of base stations to which terminal stations are connectable, the base station control device comprising:
a processor; and
a storage medium having computer program instructions stored thereon, when executed by the processor, perform to:
collect wireless environment information indicating wireless environments around the base stations and the terminal stations from each of the base stations;
calculate a parameter for correcting radio wave interference relationship among the base stations based on the wireless environment information and priority set in advance for each of the base stations; and
transmit the parameter calculated by the parameter calculation unit to each of the base stations.

7. A communication control method for controlling each of a plurality of base stations to which terminal stations are connectable, the communication control method comprising:
an information collection step of collecting wireless environment information indicating wireless environments around the base stations and the terminal stations from each of the base stations;
a parameter calculation step of calculating a parameter for correcting radio wave interference relationship among the base stations based on the collected wireless environment information and priority set in advance for each of the base stations; and
a transmission step of transmitting the calculated parameter to each of the base stations.

8. A non-transitory computer-readable medium having computer-executable instructions that, upon execution of the instructions by a processor of a computer, cause the computer to function as the wireless communication system according to claim 1.
